(19) United States
(12) Patent Application Publication
(10) Pub. No.: US 2008/0135114 A1
(43) Pub. Date: Jun. 12, 2008

(54) Multiplexed Hydraulic Valve Actuation Devices And Methods

(75) Inventors: Shuichi Takayama, Ann Arbor, MI (US); Wei Gu, Ann Arbor, MI (US); Jens-Christian Meiners, Saline, MI (US); Hao Chen, Ann Arbor, MI (US); Yi-Chung Tung, Ann Arbor, MI (US)

Correspondence Address: Casimir Jones, S.C., 440 Science Drive, Suite 203, Madison, WI, 53711, US

(73) Assignee: THE REGENTS OF THE UNIVERSITY OF MICHIGAN, Ann Arbor, MI (US)

(21) Appl. No.: 11/833,014

(22) Filed: Aug. 2, 2007

Related U.S. Application Data
(60) Provisional application No. 60/834,949, filed on Aug. 2, 2006.
(60) Provisional application No. 60/877,262, filed on Dec. 27, 2006.

(51) Int. Cl. F16K 31/44

(52) U.S. Cl. 137/561 R; 137/1

(57) ABSTRACT

The invention relates to microfluidic devices and methods for using the same. In particular, the present invention provides a multiplexed hydraulic valve actuation device, systems utilizing the device, and methods of using such devices.

This Application claims priority to provisional applications Ser. Nos. 60/834,949, filed Aug. 2, 2006, and 60/877,262, filed Dec. 27, 2006, each of which is herein incorporated by reference.

This application was supported by Grant number DAAD19-03-1-0168 awarded by the U.S. Army Research Office, Grant number BES-0238625 awarded by the National Science Foundation, and Grant number HL084370-01 and GM65934-01 awarded by the National Institutes of Health. The government has certain rights in the invention.

### FIELD OF THE INVENTION

The invention relates to microfluidic devices and methods for using the same. In particular, the present invention provides a multiplexed hydraulic valve actuation device, systems utilizing the device, and methods of using such devices.

### BACKGROUND OF THE INVENTION

Microfluidic devices allow a user to work with nano- to microliter volumes of fluids and are useful for reducing reagent consumption, creating physiologic cell culture environments that better match the fluid-to-cell-volume ratios in vivo, and performing experiments that take advantage of low Reynolds number phenomenon such as subcellular treatment of cells with multiple laminar streams. Many microfluidic systems are made of polydimethylsiloxane (PDMS) because of its favorable mechanical properties, optical transparency, and bio-compatibility.

Many microfluidic systems utilized pneumatic actuation using multilayer soft lithography (MSL), which enables operation of up to thousands of valves in parallel using far fewer control lines. However, it is dependent on macroscopic switches and external pressure sources that require fragile interconnects and limit the portability of microfluidic devices. What is needed are robust and inexpensive systems for valving and pumping microfluidic devices.

### SUMMARY OF THE INVENTION

The invention relates to microfluidic devices and methods for using the same. In particular, the present invention provides a multiplexed hydraulic valve actuation device and methods of using such devices and systems employing such devices as a component part.

For example, in some embodiments, the present invention provides a microfluidics device, comprising: one or more control channels configured to house a non-volatile and low-material permeability liquid (e.g., an ionic fluid); one or more actuators (e.g., tactile Braille actuators), wherein one or more of the actuators is in active communication with one or more of the control channels; and one or more fluidic channels, wherein one or more of the fluidic channels is in active communication with the one or more control channels. In some embodiments, the device further comprises one or more pistons, wherein one or more of the pistons is in active communication with the one or more control channels and one or more of the actuators. In some embodiments, at least of portion of the control and/or fluidic channels are composed of a flexible material. In some embodiments, the fluid channels are deformable upon contact with the control channels. In some embodiments, each of the control channels is in active communication with 2 or more of the fluidic channels. In some embodiments, the one or more control channels are closed. In some embodiments, the one or more fluidic channels are closed.

The present invention further provides a method, comprising moving the actuator of a microfluidics device comprising one or more control channels configured to house a non-volatile and low-material permeability liquid (e.g., an ionic liquid); one or more actuators (e.g., tactile Braille actuators), wherein one or more of the actuators are in active communication with one or more of the control channels; and one or more fluid channels, wherein one or more of the fluid channels is in active communication with one or more of the one or more control channels under conditions such that fluid moves through the control channels and compresses the fluid channels. In some embodiments, the action of compressing the fluidic channels results in the movement of fluid through the fluid channels. In some embodiments, the device further comprises one or more pistons, wherein one or more of the pistons is in active communication with the one or more control channels and one or more of the actuators. In some embodiments, the fluidic channels contain cells. In some embodiments, the fluidic channels are filled with components of a diagnostic assay (e.g., nucleic acids, polypeptides, antibodies, buffers, or detection components).

In additional embodiments, the present invention provides a microfluidics device, comprising: one or more pistons configured to house a non-volatile and low-material permeability liquid (e.g., an ionic liquid); one or more actuators, wherein one or more of the actuators are in active communication with one or more of the pistons, wherein one or more of the actuators is configured to pressurize one or more of the pistons. The present invention further provides systems employing the devices or methods described above. In some embodiments, the device is coupled, directly or indirectly, with one or more of: a computer system, control software, imaging devices, a communication system, an incubator, a fluid handling system, a cell handling system, etc.

Additional embodiments of the present invention are described below.

### DESCRIPTION OF THE FIGURES

FIG. 1 shows: (a) Schematic of an exemplary hydraulic valve and a top-down view with an open valve. The clear bulk material is PDMS, including the flexible membrane between the control and fluidic channels at their intersection. Schematics are not drawn to scale; the piston has an average diameter of ˜910 μm and a height of 152 μm, whereas valve intersections are typically 100×100 μm with 9 μm high fluidic channels and ˜16 μm high control channels. The valve and piston can be centimeters apart; (b) The same schematic with a vertical translation of a piezoelectrically driven Braille pin and a top-down view with a close valve and a pressurized control channel; (c) A top-down view of four intersections of pressurized control and fluidic channels. All channels are 9 μm high and 100 μm wide except for the lower right control channel that is 40 μm wide.

FIG. 2 shows: (a) a graph of the abilities of valves to stay closed when actuated by different control channel fluids at time 0. The ionic liquid filled control channels consistently sustain valve closure over all observed periods. The y axis is normalized to the lowest and beginning (before the valve is shut) values; (b) A graph of a valve filled with ionic liquid actuated in repetition. Channel dimensions here are 150 and 100 μm wide for the control and fluidic channels respectively.

FIG. 3 shows: Simulation of hydraulic valves. Both equivalent circuits are numerically solved by the commercial software Simulink (The MathWorks Inc., MA) with piecewise linear electrical circuit simulation (PLECS) (Plexim, Zurich, Switzerland) toolbox. (a) & (b) The equivalent circuit models of ionic liquid filled and air filled control lines. (c) Simulation of different response times based on control line length and hydraulic fluid. The duration of the response times matches recorded durations. (d) The simulation result with ionic liquid is matched against experimental results.

FIG. 4 shows the fabrication of an exemplary hydraulic actuation device.

### DEFINITIONS

To facilitate an understanding of the present invention, a number of terms and phrases are defined below:

The term “sample” in the present specification and claims is used in its broadest sense. On the one hand it is meant to include a specimen or culture. On the other hand, it is meant to include both biological and environmental samples. A sample may include a specimen of synthetic origin.

Biological samples may be animal, including human, fluid, solid (e.g., stool) or tissue, as well as liquid and solid food and feed products and ingredients such as dairy items, vegetables, meat and meat by-products, and waste. Biological samples may be obtained from all of the various families of domestic animals, as well as feral or wild animals, including, but not limited to, such animals as ungulates, bear, fish, lagamorphs, rodents, etc.

Environmental samples include environmental material such as surface matter, soil, water and industrial samples, as well as samples obtained from food and dairy processing instruments, apparatus, equipment, utensils, disposable and non-disposable items. These examples are not to be construed as limiting the sample types applicable to the present invention.

As used herein, the term “cell” refers to any eukaryotic or prokaryotic cell (e.g., bacterial cells such as E. coli, yeast cells, mammalian cells, avian cells, amphibian cells, plant cells, fish cells, and insect cells), whether located in vitro or in vivo.

As used herein, the term “cell culture” refers to any in vitro culture of cells. Included within this term are continuous cell lines (e.g., with an immortal phenotype), primary cell cultures, transformed cell lines, finite cell lines (e.g., non-transformed cells), and any other cell population maintained in vitro.

As used, the term “eukaryote” refers to organisms distinguishable from “prokaryotes.” It is intended that the term encompass all organisms with cells that exhibit the usual characteristics of eukaryotes, such as the presence of a true nucleus bounded by a nuclear membrane, within which lie the chromosomes, the presence of membrane-bound organelles, and other characteristics commonly observed in eukaryotic organisms. Thus, the term includes, but is not limited to such organisms as fungi, protozoa, and animals (e.g., humans).

As used herein, the term “in vitro” refers to an artificial environment and to processes or reactions that occur within an artificial environment. In vitro environments can consist of, but are not limited to, test tubes and cell culture. The term “in vivo” refers to the natural environment (e.g., an animal or a cell) and to processes or reaction that occur within a natural environment.

The terms “test compound” and “candidate compound” refer to any chemical entity, pharmaceutical, drug, and the like that is a candidate for use to treat or prevent a disease, illness, sickness, or disorder of bodily function. Test compounds comprise both known and potential therapeutic compounds. A test compound can be determined to be therapeutic by screening using the screening methods of the present invention. In some embodiments of the present invention, test compounds include antisense compounds.

As used herein, the term “processor” refers to a device that performs a set of steps according to a program (e.g., a digital computer). Processors, for example, include Central Processing Units (“CPUs”), electronic devices, or systems for receiving, transmitting, storing and/or manipulating data under programmed control.

As used herein, the term “memory device,” or “computer memory” refers to any data storage device that is readable by a computer, including, but not limited to, random access memory, hard disks, magnetic (floppy) disks, compact discs, DVDs, magnetic tape, flash memory, and the like.

### DETAILED DESCRIPTION OF THE INVENTION

The invention relates to microfluidic devices and methods for using the same. In particular, the present invention provides a multiplexed hydraulic valve actuation device and methods of using such devices and systems employing such devices as a component part.

In particular, embodiments of the present invention provide a multiplexed hydraulic valve actuation device, method of using, and systems employing the device. In contrast to presently available devices, the hydraulically actuated devices of the present invention can be portable and manufactured inexpensively.

Automation, miniaturization, and integration of chemical and biological experiments has made substantial strides with microfluidic devices (Bums et al., Science 282,484 (1998); Shaikh et al., Proc. Natl. Acad. Sci U.S.A. 102, 9745 (2005). Important to the development of microfluidic systems is the robust regulation of fluid flow within a network of microscale channels. A general class of fluid control uses deformable boundaries to mechanically push, pull, and redirect liquid. Examples include pneumatic valves (Unger et al., Science 288, 113 (2000)) based on multi-layer soft lithography (MSL), thermopneumatic valves (Yang et al., Sens. Actuators A Phys. 64, 101 (1998)), electrorheological-fluid-based valves (Niu et al., Appl. Phys. Lett. 87,243501 (2005)), and deformable hydrogels (Beebe et al., Nature 404, 588 (2000), Another mechanical strategy employs the use of a grid of protruding pins aligned below channels separated by approximately 100-150 μm of a flexible barrier in between. The movement of a pin deforms the surface of a microfluidic chip and valves shut an adjacent channel. The external driving component can be palm sized and made portable (Futai et al., Lab Chip 6, 149 (2006)) using commercial Braille display actuator components holding 16 to 1500 pins that each have the capacity to be independently driven (KGS America, Metec AG in Germany).

There are limitations in the usage of Braille pins for flow control. Since pins have a constant contact diameter on PDMS of approximately 0.8 mm and are regularly arranged in a grid, there is little flexibility in the organized placement of pins as valves and pumps. Also, such an arrangement lacks multiplexing capability as each pin operates one valve, which in turn limits the number of valves on a chip to the number of Braille pins. A different mechanical control strategy is to use dynamic pneumatic pressure within a “control” channel directly above a compressible “fluidic” channel holding the regulated fluid (Shaikh et al., supra; Unger et al., supra). The use of MSL and pneumatic valves permits the use of soft materials such as poly(dimethylsiloxane) (PDMS), the ability to pack microvalves more tightly together in designable configurations (Urbanski et al., Lab Chip 6, 96 (2006)), and a scale-up of many valves in parallel (Hansen et al., Proc. Natl. Acad. Sci U.S.A. 99, 16531 (2002)).

In some embodiments, the present invention provides the added advantage of hydraulically actuated control channels comprising ionic liquid. This allows for the rapid and robust multiplexing of microfluidic channels in, for example, a low cost and portable chip.

### I. Microfluidics Device

The device of embodiments of the present invention can be constructed using any suitable method. In some embodiments, the microfluidic devices of embodiments of the present invention comprise a hydraulically driven actuation component and a microfluidics component.

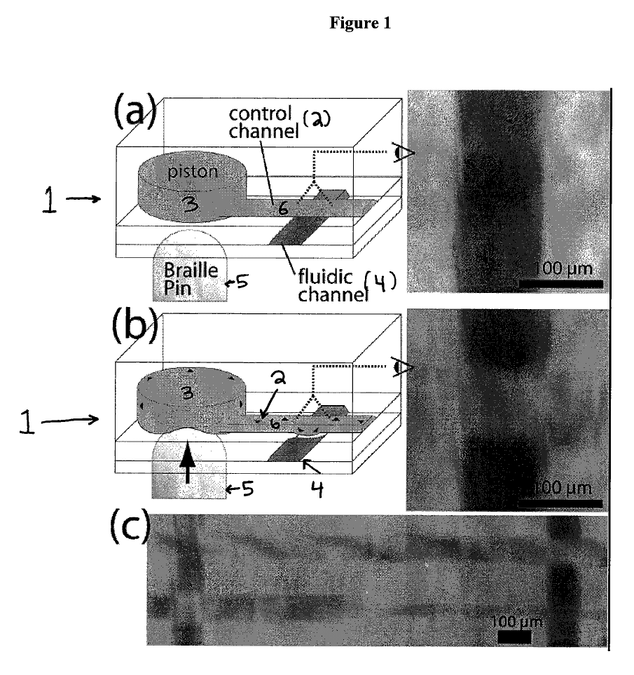

An exemplary device of embodiments of the present invention is shown in FIG. 1A. The device (1) includes a control channel (2), a fluidic channel (4), a piston (3), and an actuator (shown in FIG. 1A as the optional embodiment of a Braille pin) (5). The control channel (2) is filled with hydraulic fluid (6). At least a portion (e.g., the portion to be deformed) of the control and fluid channels is preferably constructed from flexible materials. The control and fluid channels are preferably closed channels. The hydraulic fluid is preferably an ionic liquid or other liquid that is non-volatile and has low permeability. Ionic liquids are particularly useful as hydraulic fluids because they can hold pressure within a control channel for very long times compared to other liquids because they are non-volatile and have very low permeability.

FIG. 1A shows the device (1) in an open configuration. The actuator (5) is in the “down” position such that the hydraulic fluid is not moving through the control channel (2). FIG. 1(b) shows the device in a closed configuration. The actuator (5) is in the “up” position such that the hydraulic fluid (6) flows through the control channel (2) and pushes on the fluidic channel (4), thus restricting flow through the fluidic channel (4). The device thus utilizes such actuation to control the flow of fluid and biological materials through the fluidic channels (4).

In some embodiments, the device (1) of embodiments of the present invention is utilized to provide multiplexed hydraulically actuated systems. For example, in some embodiments, a single control channel (2) is used to control more than one fluidic channel (4). In some embodiments, devices and systems of embodiments of the present invention comprise greater than one control channel (e.g., more than 5, more than 10, more than 50 or more than 100). In some embodiments, devices and systems of embodiments of the present invention comprise greater than one fluidic channel (e.g., more than 5, more than 10, more than 50 or more than 100).

In some embodiments, the control channels (2) of the device are filled with hydraulic fluid (6) that is an ionic liquid. The use of ionic liquid provides the advantage of not evaporating or leaking like a volatile liquid or gas. The use of ionic liquid provides the further advantage over a viscous fluid of being quicker to deform and thus allowing for more rapid valving and pumping. The ionic fluid filled channels are further suitable for use with small volumes of fluid and are able to maintain pressure long term. The devices of these embodiments of the present invention are thus suitable for long term use. The use of hydraulics further results in a portable, small, and low cost device.

### A. Construction of Devices

In some embodiments, construction of fluidic devices is preferably by soft lithography techniques as described for example by Duffy et al (Analytical Chem 70 4974-4984 1998; See also Anderson et al, Analytical Chem 72 158-64 2000 and Unger et al., Science 288 113-16 2000). Addition-curable RTV-2 silicone elastomers such as SYLGARD.RTM 184 Dow Corning Co can be used for this purpose. The dimensions of the various flow channels are readily determined by volume and flow rate properties etc. Channels that are designed for complete closure are preferably of a depth such that the elastomeric layer between the microchannel and the actuator can approach the bottom of the channel. Manufacturing the substrate of elastomeric material facilitates complete closure in general as does also cross-section which is rounded particularly at the furthest corners further from the actuator. The depth also depends, for example, on the extension possible for the actuators extendable protrusions. Thus channel depths may vary from a depth of less than 100 μm preferred more preferably less than 50 μm. Channel depths in the range of 10 μm-40 μm are preferred for the majority of applications but even very low channel depths (e.g., nm) are feasible and depths of 500 μm are possible with suitable actuators particularly if partial closure partial valving is sufficient.

The substrate may be of one layer or plurality of layers. The individual layers may be prepared by numerous techniques including laser ablation, plasma etching, wet chemical methods, injection molding, press molding, etc. Casting from curable silicone is most preferred, particularly when optical properties are important. Generation of the negative mold can be made by numerous methods all of which are well known to those skilled in the art. The silicone is then poured onto the mold degassed if necessary or desired and allowed to cure. Adherence of multiple layers to each other may be accomplished by conventional techniques.

A preferred method of manufacture of some devices employs preparing a master through use of negative photoresist SU-8 50 photoresist from Micro Chem Corp Newton Mass. The photoresist may be applied to glass substrate and exposed from the uncoated side through suitable mask. Since the depth of cure is dependant on factors such as length of exposure and intensity of the light source features ranging from very thin up to the depth of the photoresist may be created. The unexposed resist is removed leaving a raised pattern on the glass substrate. The curable elastomer is cast onto this master and then removed. The material properties of SU-8 photoresist and the diffuse light from an inexpensive light source can be employed to generate microstructures and channels with cross-sectional profiles that are rounded and smooth at the edges yet flat at the top i.e bell-shaped. Short exposures tend to produce radiused top while longer exposures tend to produce flat top with rounded corners. Longer exposures also tend to produce wider channels. These profiles are ideal for use as compressive deformation-based valves that require complete collapse of the channel structure to stop fluid flow as disclosed by Unger et al., (Science (2000) 288: 113). With such channels, Braille-type actuators produced full closure of the microchannels thus producing very useful valved microchannels. Such shapes also lend themselves to produce uniform flow fields and have good optical properties as well. In a typical procedure, a photoresist layer is exposed from the backside of the substrate through mask, for example, photoplotted film, by diffused light generated with an ultraviolet UV transilluminator. Bell-shaped cross-sections are generated due to the way in which the spherical wavefront, created by diffused light penetrates into the negative photoresist. The exposure dose dependent change in the SU-8 absorption coefficient is 3985 m-1 unexposed to 9700 m-1 exposed at 365 nm limits exposure depth at the edges. The exact cross-sectional shapes and widths of the fabricated structures are determined by a combination of photomask feature size exposure 20 time/intensity resist thickness and distance between the photomask and photoresist. Although backside exposure makes features which are wider than the size defined by the photomask, and in some cases smaller in height compared to the thickness of the original photoresist coating, the change in dimensions of the transferred patterns is readily predicted from mask dimensions and exposure time. The relationship between the width of the photomask patterns and the photoresist patterns obtained is essentially the linear slope of beyond certain photomask aperture size. This linear relationship allows straightforward compensation of the aperture size on the photomask through simple subtraction of constant value. When exposure time is held constant there is a threshold aperture size below which incomplete exposure will cause the microchannel height to be lower than the original photoresist thickness. Lower exposure doses will make channels with smoother and more rounded cross-sectional profiles. Light exposure doses that are too slow or photoresist thicknesses that are too large however, are insufficient in penetrating through the photoresist, resulting in cross-sections that are thinner than the thickness of the original photoresist.

### B. Actuators

In some embodiments, the pressure required to activate the hydraulic pistons of the device is supplied by an external tactile device such as are used in refreshable Braille displays. The tactile actuator contacts the active portion of the device and when energized extends and presses upon the deformable elastomer restricting or closing the feature in the active portion. Rather than close or restrict feature by being energized the tactile actuator may be manufactured in an extended position which retracts upon energizing or may be applied to the microfluidics device in an energized state closing or restricting the passage further opening the passage upon de-energizing. In some embodiments, actuators are programmable Braille display devices such as those commercially available from Telesensory as the NAVIGATOR Braille Display with GATEWAY software which directly translates screen text into Braille code. Braille displays are available from Handy Tech Blazie and Alva among other suppliers. These devices generally provide a linear array of 8-dot cells, each cell and each cell dot of which is individually programmable. Such devices are used by the visually impaired to convert row of text to Braille symbols one row at time for example to read textual message books, etc. Additional commercially available or otherwise constructed Braille devices may be used in the devices.

As described above, the microfluidic device active portions are designed such that they are positionable below respective actutable dots or protrusions on the Braille display. However to increase flexibility, it is possible to provide regular rectangular arrays usable with plurality of microfluidics devices. The more close the spacing and the higher the number of programmable extendable protrusions, the greater the flexibility in design of microdevices. Addressability also follows from customary methods. Suitable Braille display devices suitable for non-integral use are available from Handy Tech Electronik GmbH Horb Germany as the Graphic Window Professional GWP having an array of 24×16 tactile pins. Pneumatic displays operated by microvalves have been disclosed by Orbital Research Inc said to reduce the cost of Braille tactile cells from $70 U.S per cell to 5-10$/cell. Piezoelectric actuators are also usable where piezoelectric element replaces the electrorheological fluid and electrode positioning is altered accordingly. Additional actuator devices may be used in the methods of the present invention and are known to those of skill in the art (See e.g., U.S. patent publication 20070090166, herein incorporated by reference).

### II. Uses of Microfluidics Devices

The microfluidic devices of the present invention have many uses. The miniaturization and portability of microfluidics find use in a variety of research, diagnostic, industrial and clinical applications. In some embodiments, the microfluidics devices of embodiments of the present invention find use in cell sorting, cell growth (See e.g., U.S. Patent applications 20070090166 and 20070084706, each of which is herein incorporated by reference), and cell culture. Other uses include, but are not limited to, lab on a chip type assays (e.g., diagnostic or research assays), electrophoresis, electrospray ionization, small volume biological sample preparation (e.g. cell lyses, DNA extraction, DNA purification, on-chip PCR) or a combination thereof, analyses of DNA or drugs, screening of patients, and combinatorial synthesis.

### EXPERIMENTAL

The following examples are provided in order to demonstrate and further illustrate certain preferred embodiments and aspects of the present invention and are not to be construed as limiting the scope thereof.

### EXAMPLE 1

### A. Methods

### Device Fabrication and Preparation

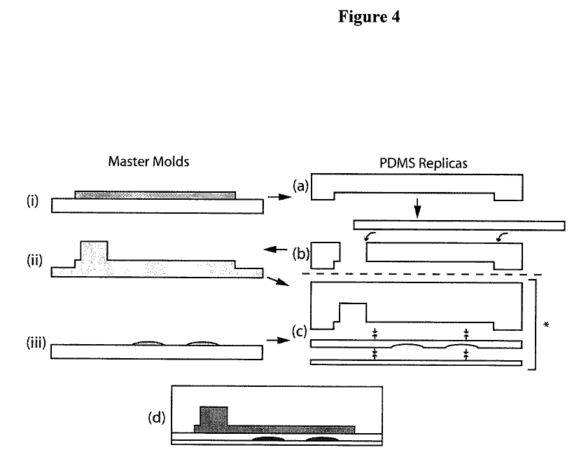

A schematic of the fabrication process is shown in FIG. 4. Silicon molds (i & iii) are fabricated through previously described photolithography techniques (Unger et al., supra). The photoresist AZ 9260 (Microchem Co., Newton, Mass.) for control and fluidic channels are spun on silicon wafers at 2000 and 3500 rpm respectively for 35 seconds and cured. The final control layer mold (ii) is made by punching holes in a thin (˜150 um thick) replica (a) of the original control channels on silicon (i) and then incorporating the space of the punched hole as a piston. We used photocurable epoxy (Epoxy Technology, Billerica, Mass.) as the second mold (ii) and cast this mold while the original PDMS replica (b) was placed upside down.

With the 3 layers (c) derived from the final control mold (ii), the fluidic mold (iii), and another flat substrate (glass or outside of a Petri dish), all 3 are sequentially bonded together with plasma oxidation (50 W, 300 mTorr, 30 seconds). In (d), a side-view showing 3 layers: top layer for control piston and channel, middle for the fluidic channels, and a last layer to seal the fluidic channels. The control channels are primed with its hydraulic liquid immediately after plasma oxidation then sealed with superglue. The liquid enters spontaneously but can also be introduced with positive pressure before permanently sealing the channel input with superglue or other suitable sealants (silicone).

### Equivalent Circuit Model of Hydraulic Control Line in Multi-Layer PDMS Microfluidic System

The objective of exploiting the equivalent circuit model is to estimate the pressure transfer within the hydraulic control line in MSL microfluidic system. The underlying fluid model is based on the Navier-Stokes equation. There are three basic components: fluid resistance, capacitance, and inductance that will be used to derive the model.

### Fluid Resistance

Analogous to electrical resistance, fluid resistance is defined as the ratio of pressure drop over flow rate,

$$R = \frac{Δ P}{Q} in \frac{N \cdot s}{{m}^{5}}$$

where ΔP is the pressure difference, in N/m², and Q is the volume flow rate, in m³/s. For a pipe with a rectangular cross section with width w, and depth h, and assuming both, laminar flow and Newtonian fluid, the resistance is

$$R = {\frac{12 µL}{w \cdot {h}^{3}} [ 1 - \frac{h}{w} ( \frac{192}{{π}^{5}} {\sum }_{n = 1}^{∞} \frac{1}{{n}^{5}} tanh ( \frac{n π w}{h} ) ) ]}^{- 1}$$

For gas diffusion through the permeable material, and assuming constant diffusion coefficient and constant flux, the 1-D Fick's first law for steady state is:

$$J ( x , t ) = - D \frac{\partial c ( x , t )}{\partial x}$$

which can be simplified to

$$J = - D \frac{d c}{d x}$$

For the linearized approximation, concentration c can be written as,

$$c = \frac{n}{V} = \frac{P}{RT} \\ ⇒ \frac{d c}{d x} = ( \frac{1}{RT} ) \frac{d P}{d x} \approx \frac{Δ P}{Δ X}$$

where ΔX is the thickness of the permeable material that air diffuses through. Therefore, the Fick's law becomes,

$$J = \frac{ρ \cdot Q}{A} = - D \cdot ( \frac{1}{RT} ) \cdot ( \frac{Δ P}{Δ X} ) \\ ⇒ R = \frac{Δ P}{Q} = - \frac{ρ \cdot RT}{D \cdot A Δ X}$$

### Fluid Capacitance

Compliant elements of a fluidic system exhibit the fluidic equivalent of capacitance as a pressure-dependent volume change

$$C = \frac{d V}{d P} in \frac{{m}^{5}}{N}$$

The fluidic capacitance for a square membrane can be derived by plate theory as

$$C = \frac{6 {a}^{6} ( 1 - {ν}^{2} )}{{π}^{4} {Et}^{3}}$$

where a is membrane width, in m, E is Young's modulus of membrane, in N/m², t is membrane thickness, in m, and v is Poisson's ratio of membrane (dimensionless)

If the fluid itself is compressible, it may represent a capacitance that can be defined in terms of the change in the number of molecules, n, in a fixed volume V, with respect to pressure changes for an ideal gas,

$$C = \frac{\partial n}{\partial P} = \frac{\partial }{\partial P} ( \frac{PV}{RT} ) = \frac{V}{RT}$$

### Fluidic Inductance

In a manner analogous to electrical inductance, fluidic systems are capable of storing kinetic energy in fluidic inductance, H (in kg/m⁴)

$$Δ P = H \frac{d Q}{d t}$$

For incompressible and inert fluidics in tubes of constant cross section A, the fluidic inductance is given by

$$H = \frac{ρ L}{A}$$

For compressible gas, the fluid inductance can be determined experimentally. First, ionic solution was filled into a close end oxygen plasma-treated PDMS microfluidic channel, which had hydrophilic walls. Air trapped in the channel would be pushed out through PDMS by the surface tension (ΔP). Assuming the volume flow of air is linearly varied through the filling process and no air volume flow (Q=0) remains after the channel is filled by ionic liquid, dQ/dt can be estimated by measuring the volume flow rate at a certain position and knowing the time period used to fill the channel from the position. As a result, fluidic inductance can be calculate by H=ΔP/(dQ/dt).

### Dimensions and Material Properties

Due to the low height to width ratio of the channels, the fluidic and control channels' cross-sectional dimensions were approximated to be rectangular. Table 1 shows the dimensions and material properties used in the simulation.

TABLE 1
The device dimensions and material properties
used for fluidic equivalent circuit simulation.
Dimensions

| | |
|---|---|
| Width of Control Channel, w_{C} | 40,100 (μm) |
| Height of Control Channel, h_{C} | 16 (μm) |
| Length of Control Channel, L_{C} | 11.9 (mm) and 38.6 (mm) |
| Width of Fluidic Channel, w_{F} | 100 (μm) |
| Height of Fluidic Channel, h_{F} | 9 (μm) |
| Length of Fluidic Channel, L_{F} | 15 (mm) |
| Width of Valve Membrane, w_{V} | 100 (μm) |
| Thickness of Valve Membrane, t | 15 (μm) |

Material Properties

| | |
|---|---|
| Dynamic Viscosity of Liquid (water), μ | 1.002 × 10⁻³ (N-s/m²) |
| Density of Liquid (water), ρ | 1.00 × 10³ (kg/m³) |
| Dynamic Viscosity of Gas (Air at 20° C.), μ | 1.82 × 10⁻⁵ (N-s/m²) |
| Density of Liquid (Air at 20° C.), ρ | 1.204 (kg/m³) |
| Diffusion Coefficient of Air in PDMS, D | 15 × 10⁵ (cm²/s) |
| Universal Gas Constant, R | 286.9 (J/kg-K) |
| Temperature, T | 293 (K) |
| Poisson's Ratio of PDMS, ν | 0.5 |
| Young's Modulus of PDMS, E | 750 (kPa) |

### B. Results

Experiments described herein are directed towards the development of hydraulic valves that are instead pressurized mechanically by pressure from movable Braille pins rather than externally delivered and switched high pressure gas (FIG. 1). Each pin movement compresses an on-chip piston and pressurizes the connected control channel (FIG. 1B). Due to the reversible pressurization of the control channel, it can close off regions of fluidic channels directly below. Each pin is approximately 0.49 mm² in contact area, and delivers 0.18 N of force to a piston. Pistons compressed by the mechanical pins are approximately 0.83 mm² in area and 150 μm in height. Typical cross-sectional dimensions are approximately 16 μm high and 95 μm wide for control channels and 8.5 μm high and 95 μm wide for fluidic channels making valve intersections approximately 100×100 μm. Similar to MLS pneumatic valves, the hydraulic valves can act on multiple fluidic channels in parallel and be able to skip fluidic channels by decreasing the width of the control channel (from 100 μm to 40 μm) (FIG. 1C). For full optical accessibility, the location of hydraulic valves can be removed away from the site of the Braille pins and pistons. Thus, the multiplexing ability and flexibility in valve placement that MLS pneumatically actuation schemes provide is retained while the advantages of interconnect-free hydraulic actuation using Braille pin actuation are realized.

Each device is composed of three bonded PDMS layers with the top control layer serving as a mold with features for both pistons and control channels. A middle layer serves as a mold for the fluidic channels as well as the membrane separating the control and fluidic channels. A bottom sheet closes the fourth side of the fluidic channels and along with the middle layer serves as the separation between pistons and the corresponding activated Braille pin.

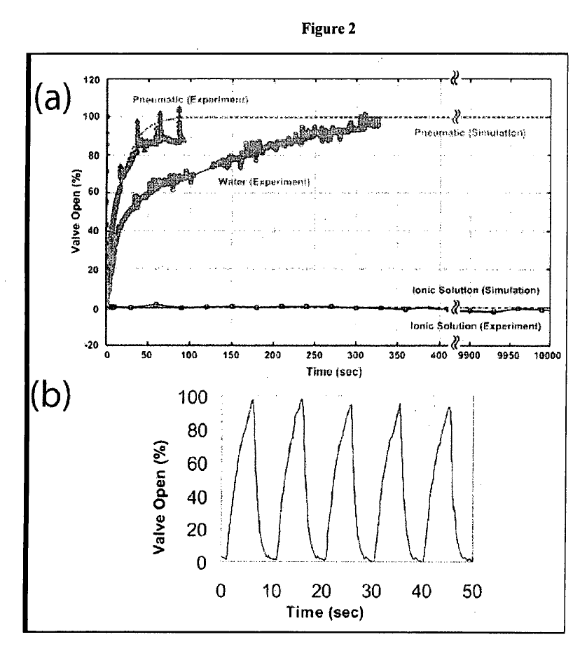

Due to little hydraulic fluid volume, it was preferred to eliminate any changes in hydraulic fluid volume due to evaporation and permeation of the hydraulic fluid through PDMS. Air or water are not well-suited for as actuating fluids, because gas permeation through the PDMS or direct evaporation causes rapid loss of pressure in the actuation channel (FIG. 2A). To overcome fluid loss, 1-butyl-3-methylimidazolium tetrafluoroborate (an ionic liquid) was used as an incompressible piston fluid. Use of ionic liquids has grown in recent years particularly as an environmentally friendly chemical solvent in part because they have no detectable vapor pressure (Rogers and Seddon, Science 302, 792 (2003)). Unlike gases such as air and vaporizable water, no decrease in ionic liquid within microfluidic channels or when open to the atmosphere over the course of >10 days was observed. In contrast to air and water, ionic liquid is the only hydraulic fluid that was able to keep a valve closed over a significant time period (FIG. 2A).

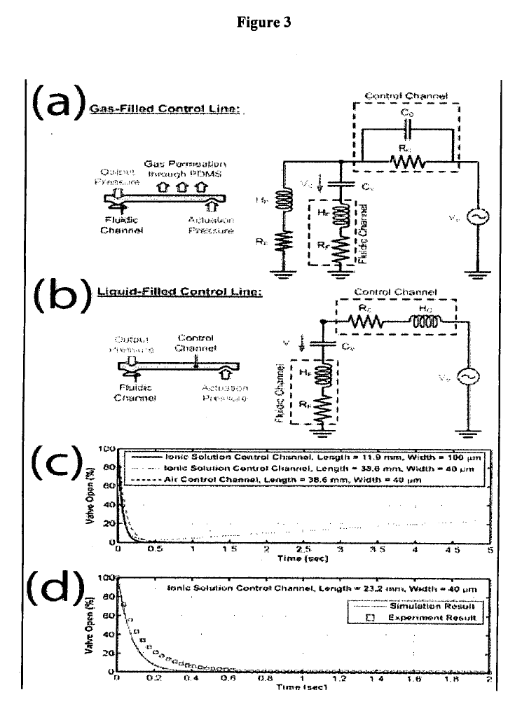

This system exhibits variably in response times between different hydraulic lines due to manual alignments between the PDMS device and the Braille pins and during fabrication of layers. Markers and alignment are used to improve variability. It also exhibits a slower opening and closing response time (−0.3-2 s) as compared to pneumatic valves (FIG. 2B). To further understand an equivalent circuit model was developed to simulate the pressure transfer within the hydraulic control lines of the device (Bourouina and Grandchamp, Journal of Micromechanics and Microengineering 6,398 (1996); Aumeerally and Sittem, Simulation Modeling Practice and Theory 14, 82 (2006). The underlying fluid model is based on the Navier-Stokes equation, and three basic components: fluid resistance, capacitance, and inductance are used to construct the models (Kovacs, Micromachined Transducers Sourcebook, the McGraw-Hill Companies, Inc., 1998; Zengerle and Richter, Journal of Micromechanics and Microengineering 4, 192 (1994)). FIGS. 3A and 3B show the equivalent circuit models to simulate the devices with control lines filled by ionic liquid and air respectively. Both solution-filled microfluidic channels and air diffusion through PDMS were simulated using series of inductors and resistors, which represent the inertial and the resistance force that fluid experience when flowing in the channel. In contrast, an air-filled microfluidic channel was simulated by a parallel combination of a capacitor and a resistance due to the compressibility of air. The membrane between the control and fluidic channels was simulated by a capacitor for its compliance. The simulation results show different behavior between the devices using ionic liquid and air to fill the control lines as observed in the experiments (FIG. 2A).

The response time of longer control channels are greater than for shorter ones. The model shows that the ionic liquid-filled control channels with length of 38.6 and 11.9 mm require approximately 0.5 and 0.3 seconds to valve, which agree with the observed response time (FIG. 3C). These agreements demonstrate that the constructed equivalent fluid circuit models are able to predict the device response reasonably well. It also indicates that minimizing the lengths of the control channels when fast actuations are required is desired.

The current limitations of the MLS pneumatic valve strategy are the dependence of each independently controlled on-chip valve on a separate pressurized tube, leading to the need for potentially numerous leak-proof interconnections. In addition, the requirement of external macroscopic compressors and valves reduces the portability of systems that are useful for several applications such as diagnostics that are at-home, point-of-care, or in rural third world settings (Jiang et al., J. Am. Chern. Soc. 125, 5294 (2003)). The described hydraulic valve control strategy has the shared advantages of both MLS pneumatic and mechanical valves through the availability of parallel, arbitrarily arranged valves that are powered by potentially many independent actuators available in a portable format. Like MLS pneumatic valves, hydraulic control channels can valve multiple fluidic channels yet skip others. The functionality of previously reported Braille valves (Gu et al., Proc. Natl. Acad. Sci U.S.A. 101, 15861 (2004)) and pumps can also be readily used in conjunction with hydraulic control valves.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in electrical engineering, optics, physics, and molecular biology or related fields are intended to be within the scope of the following claims.

We claim:

1. A microfluidics device, comprising:
a) one or more control channels configured to house a non-volatile and low-material permeability liquid;
b) one or more actuators, wherein one or more of said actuators is in active communication with one or more of said control channels; and
c) one or more fluidic channels, wherein one or more of said fluidic channels is in active communication with said one or more control channels.

2. The device of claim 1, wherein said liquid is an ionic liquid.

3. The device of claim 1, wherein said device further comprises one or more pistons, wherein one or more of said pistons is in active communication with said one or more control channels and one or more of said actuators.

4. The device of claim 1, wherein said actuator is a tactile Braille actuator.

5. The device of claim 1, wherein at least of portion of said control channels are composed of a flexible material.

6. The device of claim 1, wherein at least a portion of said fluidic channels are composed of a flexible material.

7. The device of claim 1, wherein said fluid channels are deformable upon contact with said control channels.

8. The device of claim 1, wherein each of said control channels is in active communication with 2 or more of said fluidic channels.

9. The device of claim 1, wherein said one or more control channels are closed.

10. The device of claim 1, wherein said one or more fluidic channels are closed.

11. A method, comprising
a) moving the actuator of a microfluidics device comprising one or more control channels configured to house a non-volatile and low-material permeability liquid; one or more actuators, wherein one or more of said actuators are in active communication with one or more of said control channels; and one or more fluid channels, wherein one or more of said fluid channels is in active communication with one or more of said one or more control channels under conditions such that fluid moves through said control channels and compresses said fluid channels.

12. The method of claim 11, wherein the action of said compresses said fluidic channels results in the movement of fluid through said fluid channels.

13. The method of claim 11, wherein said liquid is an ionic liquid.

14. The method of claim 11, wherein said device further comprises one or more pistons, wherein one or more of said pistons is in active communication with said one or more control channels and one or more of said actuators.

15. The method of claim 11, wherein said fluidic channels contain cells.

16. The method of claim 11, wherein said fluidic channels are filled with components of a diagnostic assay.

17. The method of claim 16, wherein said component of a diagnostic assay are selected from the group consisting of nucleic acids, polypeptides, antibodies, buffers, and detection components.

18. The method of claim 11, wherein said actuator is a tactile Braille actuator.

19. The method of claim 11, wherein at least a portion of said control channels are composed of a flexible material.

20. The method of claim 9, wherein at least a portion of said fluidic channels are composed of a flexible material.

21. The method of claim 11, wherein each of said control channels is in active communication with 2 or more of said fluidic channels.

22. The method of claim 11, wherein said one or more control channels are closed.

23. The method of claim 11, wherein said one or more fluidic channels are closed.

24. A microfluidics device, comprising
a) one or more pistons configured to house a non-volatile and low-material permeability liquid;
b) one or more actuators, wherein one or more of said actuators are in active communication with one or more of said pistons, wherein one or more of said actuators is configured to pressurize one or more of said pistons.

25. The microfluidics device of claim 24, wherein said liquid is an ionic liquid.
